(19) United States
(12) Patent Application Publication
(10) Pub. No.: US 2014/0084869 A1
(43) Pub. Date: Mar. 27, 2014

(54) METHOD AND APPARATUS FOR CHARGING AND DISCHARGING BATTERY

(71) Applicant: LG CNS Co., Ltd., (US)

(72) Inventors: Tae Hyoung Ryu, Seoul (KR); In Chol Yeon, Uijeongbu-si (KR); Cheol Kyu Han, Incheon (KR)

(73) Assignee: LG CNS CO., LTD., Seoul (KR)

(21) Appl. No.: 13/790,785

(22) Filed: Mar. 8, 2013

(30) Foreign Application Priority Data
Mar. 22, 2012 (KR) 10-2012-0029459

(51) Int. Cl. H02J 7/00

(52) U.S. Cl. CPC H02J 7/0014
USPC 320/118; 29/623.1

(57) ABSTRACT

Disclosed is an apparatus and methods for charging and discharging a battery, the apparatus including at least one tray provided in a charge/discharge structure, or detached from the charge/discharge structure, for charging and discharging, a plurality of battery cells included in the at least one tray, and a power control system to supply power to the plurality of battery cells connected in series through a power line, wherein the power control system controls a current flowing through the plurality of battery cells connected in series.

### CROSS-REFERENCE TO RELATED APPLICATION

This application claims the priority benefit of Korean Patent Application No. 10-2012-0029459, filed on Mar. 22, 2012, in the Korean Intellectual Property Office, the disclosure of which is incorporated herein by reference.

### BACKGROUND

1. Field of the Invention

The present invention relates to charging and discharging batteries and, more specifically, to a method and an apparatus for charging and discharging a plurality of battery cells connected in series.

2. Description of the Related Art

In a factory dedicated to battery cell production, two or three battery cells are typically connected in parallel on a tray and charged or discharged. Here, a number of power sources and control switch circuits needed for charging and discharging a plurality of cells is proportional to a number of cells included in a tray. Such a charging and discharging method involves a complicated circuit configuration, and since controlling a charge amount is difficult, charge and discharge times of the cells are non-uniform.

Such non-uniform charge and discharge times make estimating a time to complete charging and discharging the cells on the tray impossible, resulting in a waiting time for a process after charging and discharging and thus, efficiency of the production system is reduced.

### SUMMARY

An aspect of the present invention provides a method and an apparatus for charging and discharging a battery capable of easily controlling charge amounts and charge/discharge times of a plurality of battery cells.

Another aspect of the present invention also provides a method and an apparatus for charging and discharging a battery capable of maintaining, to be constant, a charge/discharge time of each tray, including a plurality of battery cells, to reduce a waiting time of a tool transporting the tray after charging/discharging, thereby improving efficiency of a subsequent process.

According to an aspect of the present invention, there is provided an apparatus for charging and discharging a battery, the apparatus including at least one tray provided in a charge/discharge structure, or detached from the charge/discharge structure for charging and discharging, a plurality of battery cells included in the at least one tray, and a power control system to supply power to the plurality of battery cells connected in series through a power line, wherein the power control system controls a current flowing through the plurality of battery cells connected in series.

The power control system may adjust charge/discharge times of the battery cells connected in series by controlling the current flowing through the battery cells.

The power control system may increase or decrease a current applied to the battery cells through voltage control of the supplied power.

The apparatus may further include a control switch circuit to be included in each of the at least one trays, and to control charging or discharging of the battery cells connected in series.

Common control of the control switch circuit may be performed by the battery cells as a unit.

Common control of the control switch circuit may be performed by the at least one tray as a unit.

The power control system may estimate a charge completion time of the battery cells included in the tray by measuring a generated current.

The control switch circuit may include a buck converter including at least one pair of transistors and configured to decrease an electric potential using the pair of transistors, a boost converter including another pair of transistors of the same type as the at least one pair of transistors and configured to increase an electric potential using the other pair of transistors, and a protection circuit to constantly maintain a voltage applied to the buck converter and the boost converter.

According to another aspect of the present invention, there is also provided a charging and discharging system including at least one tray including a plurality of battery cells connected in series, a moving unit to transport the at least one tray along a predetermined path for charging and discharging the plurality of battery cells included in the at least one tray, a charge/discharge structure including a power control system for supplying power to the plurality of battery cells included in the at least one tray through a power line, and a mechanical structure to place the at least one tray transported for charging and discharging to in the charge/discharge structure, wherein the plurality of battery cells are connected in series, and wherein the power control system controls a current flowing through the plurality of battery cells connected in series.

The power control system may adjust charge/discharge times of the battery cells connected in series by controlling the current flowing through the battery cells.

The charge/discharge structure may further include a control switch circuit to be included in each of the at least one trays, and to control charging or discharging of the battery cells connected in series.

Common control of the control switch circuit may be performed by the battery cells as a unit.

The control switch circuit may control charging or discharging of the battery cells connected in series by the at least one tray as a unit.

The power control system may increase or decrease a current applied to the battery cells through voltage control of the supplied power.

According to still another aspect of the present invention, there is also provided a method of charging and discharging a battery, the method including connecting a plurality of battery cells on at least one tray provided in a charge/discharge structure, or detached from the charge/discharge structure, for charging and discharging, supplying power to the plurality of battery cells through a power line connected to a power control system, controlling a voltage of the supplied power, and charging or discharging the plurality of battery cells by controlling a current flowing through the battery cells via the controlling of the voltage, wherein the plurality of battery cells are connected in series.

The method may further include adjusting charge/discharge times of the battery cells connected in series by controlling the current flowing through the battery cells.

The method may further include increasing or decreasing a current applied to the battery cells through the controlling of the voltage of the supplied power.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a charge/discharge system according to an exemplary embodiment of the present invention;

FIG. 2 illustrates a general method of charging and discharging a battery cell;

FIG. 3 illustrates a configuration of an apparatus for charging and discharging a plurality of battery cells and a charging and discharging method according to an exemplary embodiment of the present invention;

FIG. 4 illustrates charging and discharging principles of the apparatus for charging and discharging the plurality of battery cells according to an exemplary embodiment of the present invention;

FIG. 5 illustrates a structure of a control switch circuit included in the apparatus for charging and discharging the plurality of battery cells according to an exemplary embodiment of the present invention;

FIG. 6 illustrates an operation of a switch circuit for charging used in the general method of charging and discharging the battery cell;

FIG. 7 illustrates an operation of the switch circuit for discharging used in the general method of charging and discharging the battery cell; and

FIG. 8 is a flowchart illustrating a method of charging and discharging a plurality of battery cells according to an exemplary embodiment of the present invention.

### DETAILED DESCRIPTION

The invention is described more fully hereinafter with reference to the accompanying drawings, in which exemplary embodiments of the invention are shown.

This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Like reference numerals in the drawings denote like elements.

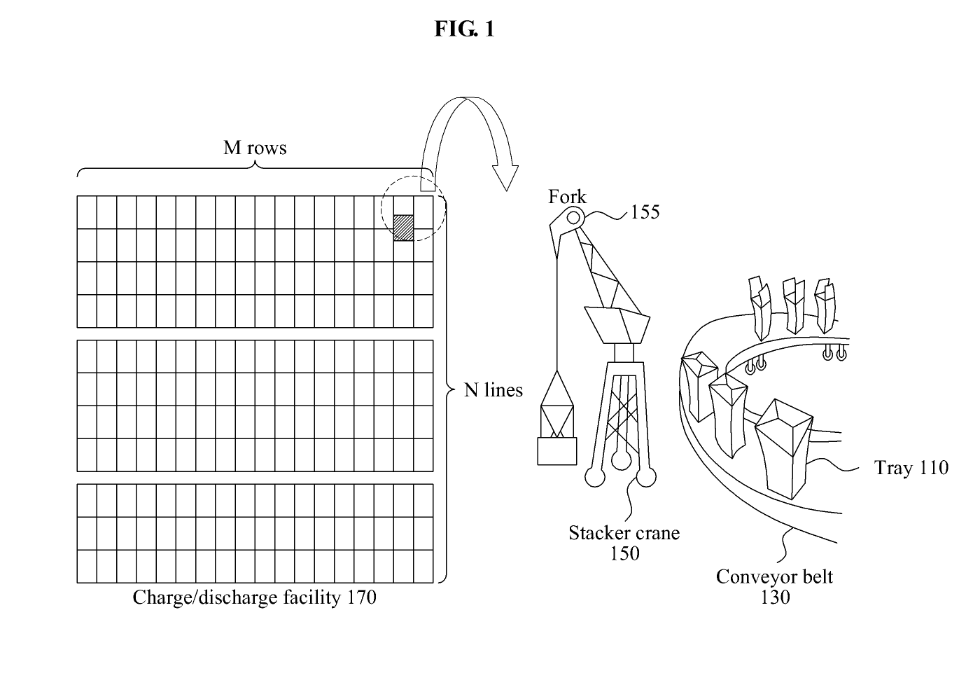

FIG. 1 illustrates a charge/discharge system according to an exemplary embodiment of the present invention.

Referring to FIG. 1, the charge/discharge system according to the present embodiment includes at least one tray 110, a moving unit 130, a mechanical structure 150, and a charge/discharge structure 170.

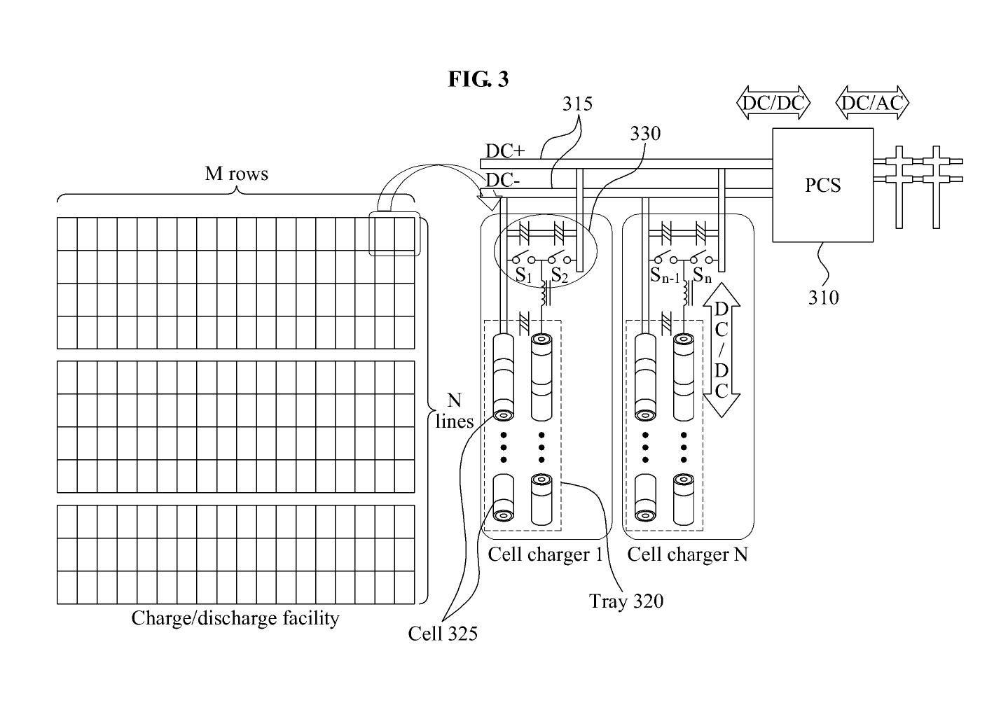

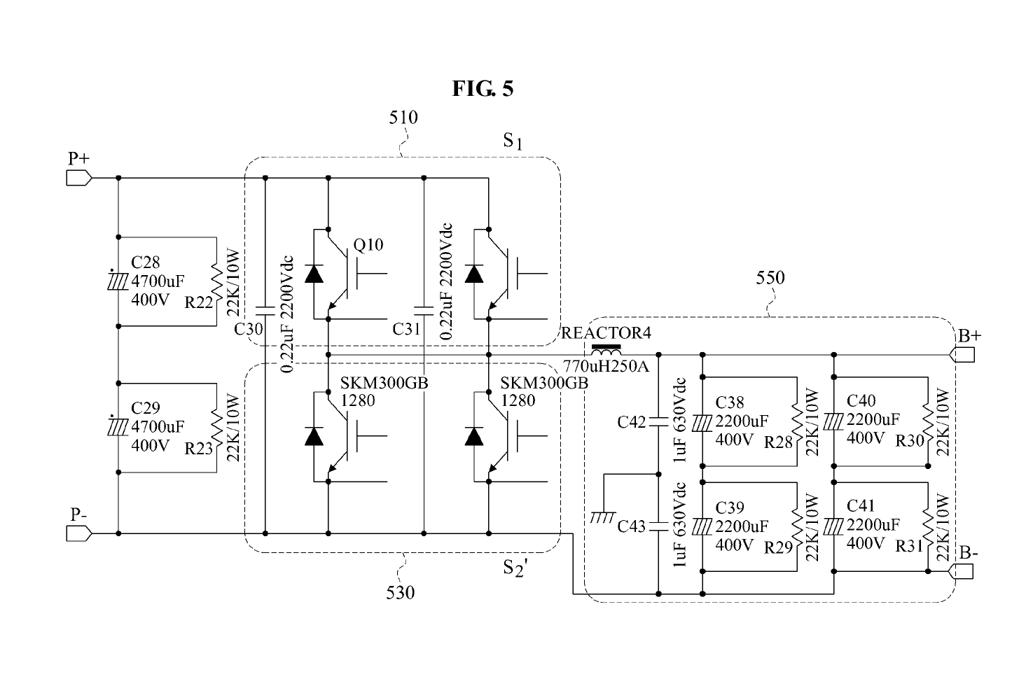

The at least one tray 110 includes a plurality of battery cells connected in series. The moving unit 130 carries the at least one tray 110 along a predetermined path in order to charge or discharge the plurality of battery cells included in the at least one tray 110. Here, the moving unit 130 may be, for example, a two-way conveyor belt. The mechanical structure 150 may allow the at least one tray carried by the moving unit 130 for charging or discharging to be provided in the charge/discharge facility 170 and returning the at least one tray 110 to the moving unit 130 after being completely charged or discharged. The mechanical structure 150 may be, for example, a stacker crane having a fork 155. The charge/discharge facility 170 includes a power control system (PCS) (not shown) to supply power to the plurality of battery cells included in the at least one tray 110 through a power line and conduct charging and discharging. Here, the plurality of battery cells included in the at least one tray 110 are connected in series. Further, the charge/discharge facility 170 may include a control switch circuit to control charging or discharging of the plurality of battery cells included in each at least one tray 110 and connected in series. Here, common control of the control switch circuit may be performed by the plurality of battery cells as a unit and control charging or discharging of the plurality of battery cells connected in series in at least one tray 110 as a unit. The PCS included in the charge/discharge facility 170 will be described in detail with reference to FIG. 3, and the control switch circuit will be described in detail with reference to FIG. 5.

The charge/discharge system according to the exemplary embodiment performs the following operations for charging and discharging.

First, when preprocessed cells neither charged nor discharged are carried by the two-way conveyor belt 130, the neither charged nor discharged preprocessed cells are transported by a tray 110 as a unit to a charge/discharge facility 170 by the fork 155 of the stacker crane 150. Here, the fork 155 is a part of the stacker crane 150 for returning the tray 110 to the conveyor belt 130 in a charge/discharge process. Here, the tray 110 may include a plurality of charged or discharged battery cells.

The neither charged nor discharged preprocessed cells are transported to the charge/discharge facility 170 to be charged or discharged on a tray by tray basis. Then, the battery cells completely charged or discharged are transported by each tray 110 to the two-way conveyor belt 130 for a subsequent process to be performed. Here, the fork 155 of the stacker crane 150 is also used to transport the tray 110.

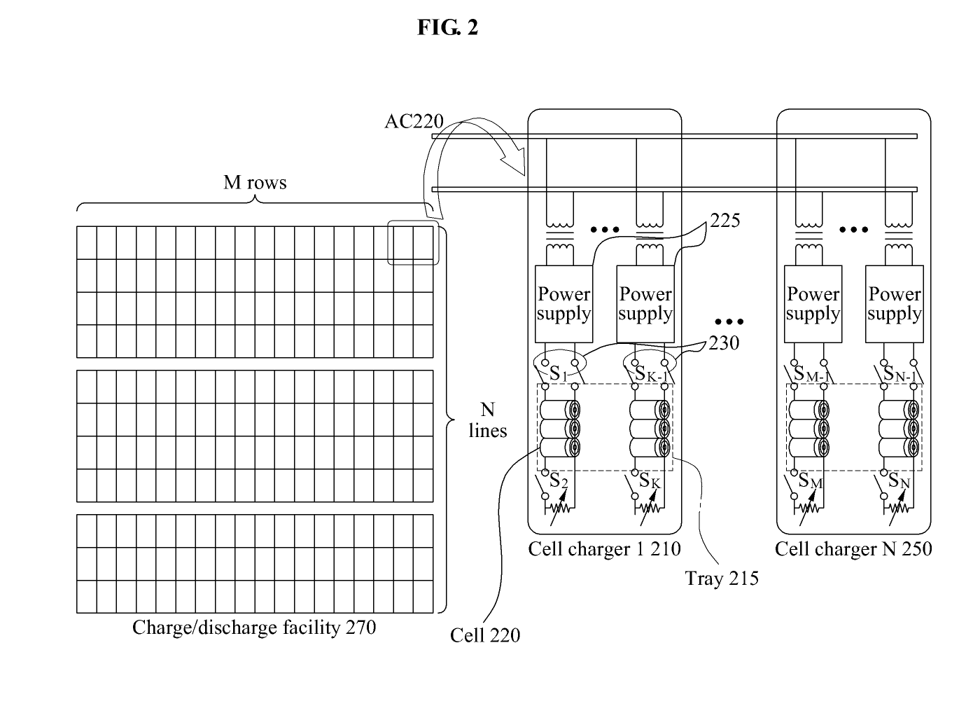

FIG. 2 illustrates a general method of charging and discharging a battery cell.

Referring to FIG. 2, a charge/discharge facility 270 may include a plurality of cell chargers, for example, a cell charger 1 210 to a cell charger N 250. Here, a power supply 225 and a control switch circuit 230 are provided for each of two or three battery cells 220 included in a tray 215 provided in one cell charger, for example, the cell charger 1 210. In particular, in the general method of charging and discharging the battery cell, the power supply 225 and the control switch circuit 230 needed are proportional to a number of battery cells 220 provided in the tray 215, thus complicating control of charging and discharging. For example, according to the general charging and discharging method, fifty control switch circuits 230 and fifty power supplies 225 are required for fifty battery cells 220.

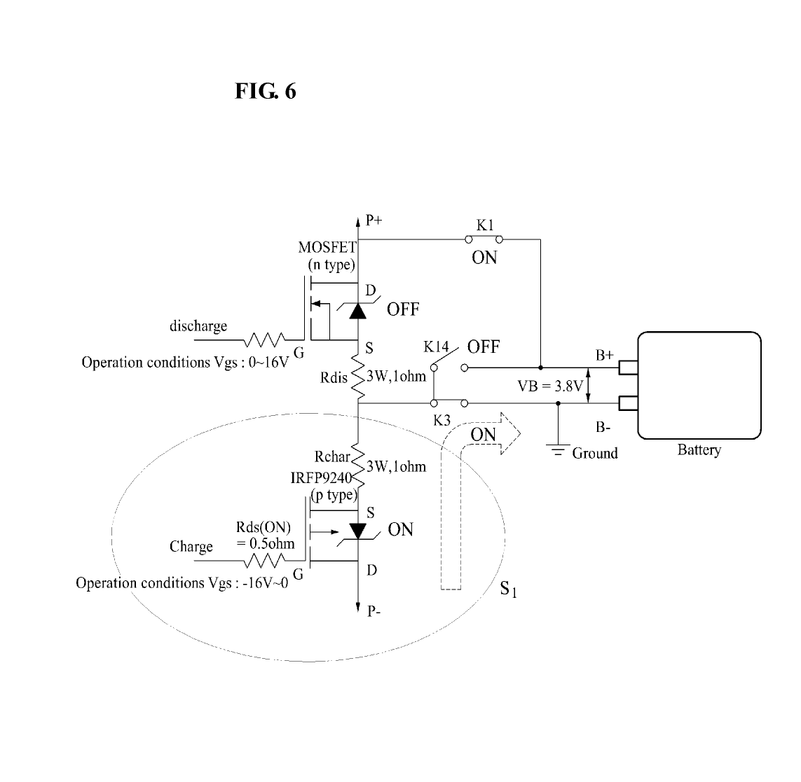

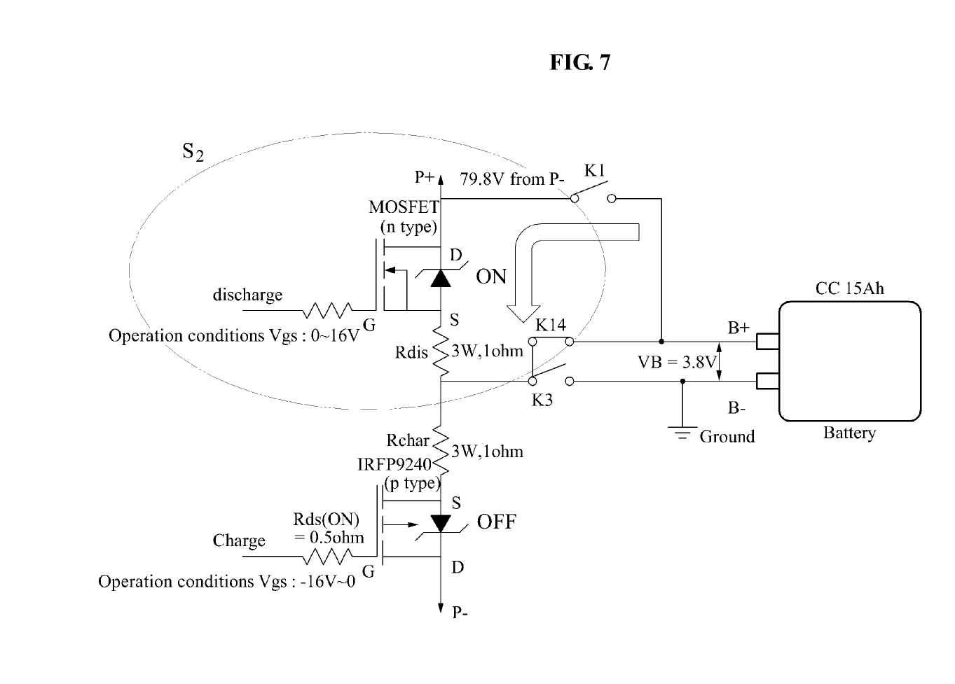

Further, in the general method of charging and discharging the battery cell, battery cells are connected in parallel and charged or discharged. In this case, control switch circuits 230 are linear circuits, which have a complicated configuration and are difficult to control an amount of charge, such that charge/discharge times are non-uniform. Operations and a structure of the control switch circuit 230 used in the general charging and discharging method in which the battery cells are connected in parallel for charging and discharging will be described with reference to FIGS. 6 and 7.

According to the general charging and discharging method in which the battery cells are connected in parallel for charging and discharging, a final time to complete charging or discharging of all battery cells included in the tray is not estimated and thus, the fork for transporting the tray after charging or discharging stands by and a waiting time of the fork leads to a decrease in efficiency with respect to a subsequent process to be performed.

FIG. 3 illustrates a configuration of an apparatus for charging and discharging a plurality of battery cells and a charging and discharging method according to an exemplary embodiment of the present invention. Referring to FIG. 3, the apparatus for charging and discharging the plurality of battery cells according to the present embodiment includes a power control system (PCS) 310, at least one tray 320, a plurality of battery cells 325, and a common control switch circuit 330.

In the present embodiment, the plurality of battery cells 325 included in the at least one tray 320 are connected in series, and structures of the PCS 310 and the control switch circuit 330 are simplified. Further, in the present embodiment, one control switch circuit 330 for controlling charging and discharging is provided for each tray and the apparatus includes one PCS 310 supplying power for charging and discharging of the battery cells.

Here, the plurality of battery cells 325 included in the at least one tray 320 are connected to the PCS 310 through +DC or −DC power lines 315.

As described above, in the present embodiment, the plurality of battery cells 325 included in the at least one tray 320 are connected in series in a charging and discharging process, and the PCS 310 and the control switch circuit 330 are simplified, thereby reducing a waiting time of a fork.

Transitively, each component operates as follows. The PCS 310 supplies power to the plurality of battery cells connected in series through the power lines 315. The PCS 310 may control a current flowing through the plurality of battery cells connected in series. Further, the PCS 310 may increase or decrease a current applied to the plurality of battery cells through controlling a voltage of the power supplied to the battery cells.

In detail, the PCS 310 raises a voltage supplied to the plurality of battery cells connected in series, in order to reduce a charge/discharge time of the battery cells, thereby increasing an amount of current flowing through the battery cells. Further, the PCS 310 reduces a voltage supplied to the plurality of battery cells connected in series in order to reduce a charge/discharge time of the battery cells, thereby decreasing an amount of current flowing through the battery cells.

In addition, the PCS 310 controls a current flowing through the battery cells, thereby adjusting a charge/discharge time of the battery cells. For example, in consideration of an example in which the PCS 310 charges or discharges of three cells included in three trays and a 5 V voltage is needed for charging each of the three cells, the PCS 310 supplies a 15 V voltage to charge all three cells. Here, when a first cell is fully charged, a 10 V voltage is required for charging the two remaining cells. In this case, the PCS 310 may control a voltage applied to the two battery cells to 10 V since the first battery cell is completely charged.

Further, the PCS 310 measures a generated current, thereby estimating a charge completion time of the battery cells in the tray.

The at least one tray 320 is provided in a charge/discharge structure or separated from the charge/discharge structure for charging/discharging. The at least one tray 320 includes the plurality of battery cells 325 connected in series.

The control switch circuit 330 is included in each of the at least one tray 320 and controls charging or discharging of the plurality of battery cells connected in series.

Each of the at least one trays 320 may include the control switch circuit 330. Here, common control of the control switch circuit 330 is performed by the plurality of battery cells as a unit and each tray 320. Here, commonly controlling the control switch circuit 330 refers to an operation in which a single control switch circuit 330 has a common effect on a plurality of battery cells or a plurality of battery cells included in one tray 320.

The control switch circuit 330 may switch to ON/OFF states when the battery cells 325 are completely charged/discharged. A structure of the control switch circuit 330 according to an exemplary embodiment will be illustrated in FIG. 5.

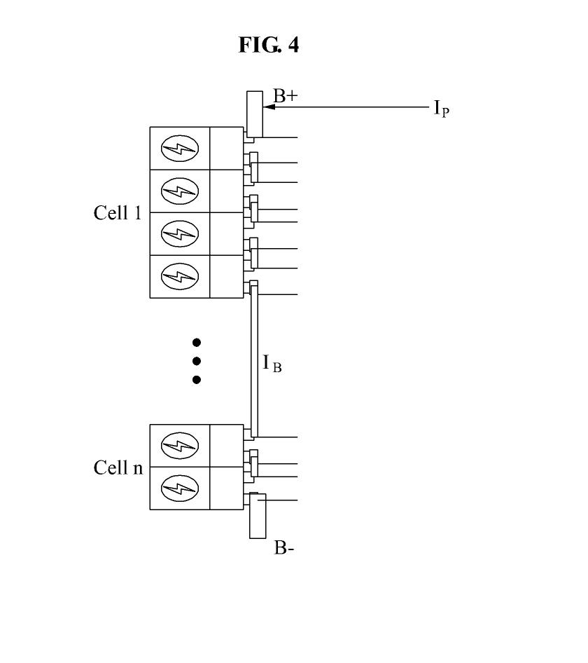

FIG. 4 illustrates charging and discharging principles of the apparatus for charging and discharging the plurality of battery cells according to the exemplary embodiment of the present invention.

Referring to FIG. 4, in the apparatus for charging and discharging the plurality of battery cells, battery cells (i.e., Cell 1 and Cell 2) included in a tray are connected in series. Here, opposite terminals of a combination of battery cells connected in series are supplied with B+and B− voltages. Subsequently, when a current I_{P} generated in a PCS is supplied to a first battery cell, Cell I, the current I_{P} flows from Cell I to a last battery cell, Cell N, for a short time. Here, the current I_{P} generated in the PCS is the same as a current I_{B} flowing to Cell N via Cell I.

Thus, charge times of the battery cells included in the tray are virtually the same, making estimation of a charge completion time of all battery cells included in the tray possible. In the present embodiment, a current generated in the PCS is measured, thereby estimating a charge completion time of a plurality of battery cells included in a tray.

Similarly, a discharge completion time may also be estimated based on the preceding principles. Here, the current I_{P} generated in the PCS may be controlled by the control switch circuit.

According to the present embodiment, charge/discharge times of all battery cells included in a tray may be easily controlled just by adjusting an amount of current supplied by one PCS. Further, a structure of the control switch circuit to be illustrated in FIG. 5 allows easy control of a direct current, thereby configuring a series charging and discharging system capable of evenly applying a current to a plurality of battery cells connected in series.

FIG. 5 illustrates a structure of the control switch circuit included in the apparatus for charging and discharging the plurality of battery cells according to an exemplary embodiment of the present invention.

Referring to FIG. 5, the control switch circuit according to the present embodiment includes a buck converter 510, a boost converter 530, and a protection circuit 550.

The buck converter 510 includes a pair of transistors and may reduce an electric potential using the pair of transistors. When the buck converter 510 is turned ON, a step-down voltage is applied to opposite terminals of a plurality of cells connected in series, thereby carrying out discharging. Here, the buck converter 510 is turned ON when a switch 51 is closed in FIG. 3.

The boost converter 530 includes another pair of transistors of the same type as the transistors used for the buck converter 510, and may increase an electric potential using the other pair of transistors. When the boost converter 530 is turned ON, a step-up voltage is applied to the opposite terminals of the plurality of cells connected in series, thereby carrying out charging. Here, the boost converter 530 is turned ON when a switch S2 is closed in FIG. 3.

Here, the buck converter 510 and the boost converter 530 may be configured as a transistor, for example, an insulated gate bipolar mode transistor (IGBT) or a field effect transistor (FET).

The protection circuit 550 maintains voltages applied to the buck converter 510 and the boost converter 530 to be constant, thereby protecting the control switch circuit from being supplied with an overvoltage or an overcurrent.

The buck converter 510 may correspond to the switch S1 in FIG. 5, and the boost converter 530 may correspond to the switch S2 in FIG. 5.

FIG. 6 illustrates an operation of a switch circuit in charging used in the general method of charging and discharging the battery cell, and FIG. 7 illustrates an operation of the switch circuit in discharging.

Referring to FIGS. 6 and 7, for example, battery cells are charged when S1 is turned ON and S2 is turned OFF, whereas the battery cells are discharged when S1 is turned OFF and S2 is turned ON.

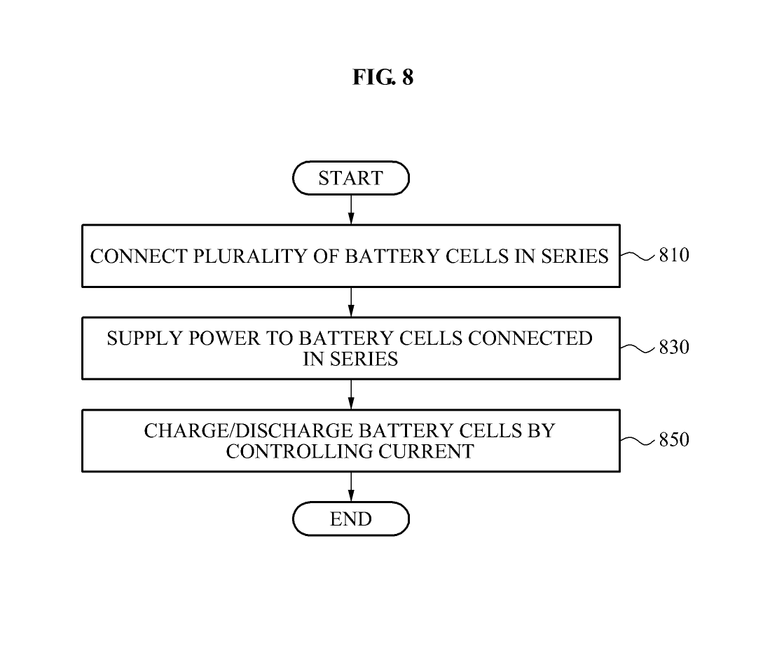

FIG. 8 is a flowchart illustrating a method of charging and discharging a plurality of battery cells according to an exemplary embodiment of the present invention.

Referring to FIG. 8, the charge/discharge system according to exemplary embodiments connects a plurality of battery cells on at least one tray using the moving unit and the mechanical structure in operation 810. Here, the at least one tray is provided in a charge/discharge structure or separated from the charge/discharge structure for charge/discharge.

The charge/discharge system supplies power to the plurality of battery cells connected in series through a power line connected to the PCS in operation 830. Subsequently, the charge/discharge system controls a current flowing through the plurality of battery cells and charges or discharges the battery cells in operation 850.

Here, the PCS may increase an amount of current flowing to the battery cells in order to reduce charge/discharge times of the battery cells or decrease an amount of current flowing through the battery cells in order to increase the charge/discharge times.

In addition, the PCS may control a voltage of the supplied power, thereby increasing or decreasing an amount of current applied to the battery cells. Moreover, the PCS may control a current flowing through the battery cells, thereby adjusting the charge/discharge times of the battery cells.

The above-described exemplary embodiments of the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to an aspect of the present invention, a current flowing through a plurality of battery cells connected in series is controlled, thereby easily controlling charge amounts and charge/discharge times of the battery cells.

According to another aspect of the present invention, a control switch circuit for controlling charge/discharge is configured as a novel type, instead of a linear circuit, thereby simplifying a configuration of the control switch circuit.

According to still another aspect of the present invention, a plurality of cells included in a tray are connected in series to make a charge/discharge time of each tray uniform, thereby reducing a waiting time for a process after charging/discharging and improving efficiency of the entire process.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for charging and discharging a battery, the apparatus comprising:
at least one tray for charging and discharging;
a plurality of battery cells included in the at least one tray; and
a power control system to supply power to the plurality of battery cells connected in series through a power line,
wherein the power control system controls a current flowing through the plurality of battery cells connected in series.

2. The apparatus of claim 1, wherein the power control system adjusts charge/discharge times of the plurality of battery cells connected in series by controlling the current flowing through the plurality of battery cells.

3. The apparatus of claim 2, wherein the power control system increases or decreases a current applied to the plurality of battery cells through voltage control of the supplied power.

4. The apparatus of claim 1, further comprising a control switch circuit to be included in each of the at least one trays, and to control charging or discharging of the plurality of battery cells connected in series.

5. The apparatus of claim 4, wherein common control of the control switch circuit is performed by the plurality of battery cells as a unit.

6. The apparatus of claim 4, wherein common control of the control switch circuit is performed by the at least one tray as a unit.

7. The apparatus of claim 1, wherein the power control system estimates a charge completion time of the plurality of battery cells included in the at least one tray by measuring a generated current.

8. The apparatus of claim 4, wherein the control switch circuit comprises:
a buck converter comprising at least one pair of transistors, the buck converter configured to decrease an electric potential using the pair of transistors;
a boost converter comprising a different pair of transistors of the same type as the at least one pair of transistors, the boost converter configured to increase an electric potential using the different pair of transistors; and
a protection circuit to maintain a constant voltage applied to the buck converter and the boost converter.

9. A charging and discharging system comprising:
at least one tray comprising a plurality of battery cells connected in series;
a moving unit to transport the at least one tray along a predetermined path for charging and discharging the plurality of battery cells included in the at least one tray;
a charge/discharge structure comprising a power control system for supplying power to the plurality of battery cells included in the at least one tray through a power line; and
a mechanical structure to dispose the at least one tray transported for charging and discharging to the charge/discharge structure,
wherein the power control system controls a current flowing through the plurality of battery cells connected in series.

10. The charging and discharging system of claim 9, wherein the power control system adjusts charge/discharge times of the plurality of battery cells connected in series by controlling the current flowing through the plurality of battery cells.

11. The charging and discharging system of claim 9, wherein the charge/discharge structure comprises a control switch circuit to be included in each of the at least one trays, and to control charging or discharging of the plurality of battery cells connected in series.

12. The charging and discharging system of claim 11, wherein common control of the control switch circuit is performed by the plurality of battery cells as a unit.

13. The charging and discharging system of claim 11, wherein the control switch circuit controls charging or discharging of the plurality of battery cells connected in series by the at least one tray as a unit.

14. The charging and discharging system of claim 9, wherein the power control system increases or decreases a current applied to the plurality of battery cells through voltage control of the supplied power.

15. A method of charging and discharging a battery, the method comprising:
connecting a plurality of battery cells on at least one tray provided in a charge/discharge structure, or detached from the charge/discharge structure, for charging and discharging;
supplying power to the plurality of battery cells through a power line connected to a power control system;
controlling a voltage of the supplied power; and
charging or discharging the plurality of battery cells by controlling a current flowing through the plurality of battery cells via the controlling of the voltage,
wherein the plurality of battery cells are connected in series.

16. The method of claim 15, further comprising adjusting charge/discharge times of the plurality of battery cells connected in series by controlling the current flowing through the plurality of battery cells.

17. The method of claim 15, further comprising increasing or decreasing a current applied to the plurality of battery cells through the controlling of the voltage of the supplied power.
